(19) United States
(12) Patent Application Publication
(10) Pub. No.: US 2013/0111983 A1
(43) Pub. Date: May 9, 2013

(54) Throttle Twist Grip

(71) Applicant: Gustav Magenwirth GmbH & Co., Bad Urach (DE)

(72) Inventor: Johann Mauch, Bad Urach (DE)

(73) Assignee: GUSTAV MAGENWIRTH GMBH & CO., Bad Urach (DE)

(21) Appl. No.: 13/632,639

(22) Filed: Oct. 1, 2012

Related U.S. Application Data
(63) Continuation-in-part of application No. PCT/EP2011/054961, filed on Mar. 30, 2011.

(30) Foreign Application Priority Data
Apr. 1, 2010 (DE) 10 2010 013 686.7

(51) Int. Cl. G01M 15/00

(52) U.S. Cl. CPC G01M 15/00
USPC 73/114.36

(57) ABSTRACT

A throttle twist grip includes a housing, a grip tube rotatable about an axis of rotation relative to the housing, a position detector having a position indicator and a sensor operable to detect relative position of the grip tube relative to the housing, a holder shaped to receive part of the position detector, and at least one of the holder being mounted rotatably about the axis in relation to the grip tube, the grip tube having a catch operable to carry along the holder upon actuation, the holder being rotatable about the axis in relation to the grip tube by an angle corresponding to idling play, a cruise control switch-off device, an angle of rotation limiting device disposed substantially in an axial plane of the holder, and a friction device operable to have a greater frictional resistance in an actuating direction than counter to the actuating direction upon actuation.

### CROSS-REFERENCE TO RELATED APPLICATIONS

This is a continuing application, under 35 U.S.C. §120, of copending International Application No. PCT/EP2011/054961 filed Mar. 30, 2011, which designated the United States and was not published in English, which designated the United States and was not published in English; this application also claims the priority, under 35 U.S.C. §119, of German patent application No. 10 2010 013 686.7 filed Apr. 1, 2010; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The invention relates to a throttle twist grip.

### BACKGROUND OF THE INVENTION

A throttle twist grip of this type is known from German Published, Non-prosecuted Patent Applications DE 100 27 193 A1 or DE 10 2006 060 345 A1, for example.

The known throttle twist grips have the drawback that the position detection device directly emits a different output signal upon actuation of the throttle twist grip in the actuating direction. Therefore, the actuation of the gas twist grip from a zero position or an idle position requires a complex evaluation to produce the idling play that a driver knows and desires from the mechanical throttle twist grips.

### SUMMARY OF THE INVENTION

Therefore, the invention provides a throttle twist grip where the position detection device emits a changed output signal upon actuation of the throttle twist grip in the actuating direction only when of an idling play has been overcome.

Advantageous embodiments of the invention are indicated in the dependent claims.

According to the invention, a throttle twist grip comprising a housing, a grip tube which is mounted rotatably about an axis of rotation in relation to the housing, a position detection device which has a position indicator and at least a sensor for detecting the relative position of the grip tube in relation to the housing and a holder for receiving part of the position detection device, wherein
the holder is mounted rotatably about the axis of rotation in relation to the grip tube, and/or
the grip tube has a catch for carrying along the holder upon actuation of the throttle twist grip, and/or
the holder is rotatable about the axis of rotation in relation to the grip tube by an angle (α) which corresponds to the idling play, and/or
the throttle twist grip has cruise control switch-off device, and/or
the throttle twist grip has an axis of rotation limiting device which is arranged in or substantially in the axial plane of the holder, and/or
the throttle twist grip has a friction device which is designed so as to have a greater frictional resistance in the actuating direction than counter to the actuating direction upon actuation of the throttle twist grip.

The exemplary embodiments of the invention, comprising the feature that the holder is mounted rotatably about the axis of rotation in relation to the grip tube and/or the grip tube has a catch for carrying along the holder upon actuation of the throttle twist grip and/or the holder is rotatable about the axis of rotation in relation to the grip tube by an angle (α) which corresponds to the idling play have the advantage that the desired idling play, offer the advantage that the desired idling play can be achieved in a strictly mechanical and simple way by the two-part design of holder and grip tube and/or the separation of holder and grip tube. In other words, the play must initially be overcome in an acceleration operation from the zero position, followed by a relative movement between the parts of the position detection device. This idling play is advantageous because it can prevent an unintended acceleration operation.

In these embodiments of the invention, the throttle twist grip advantageously has a spring device, one end of which is attached to the holder and the other end of which is attached to a part connected in rotationally fixed fashion to the handlebar, e.g. the housing of the throttle twist grip.

These embodiments of the invention have the advantage that the holder is held in the idling position by the spring device, e.g., in a position in which the holder abuts against an idling stop formed on the housing.

The embodiments of the invention, comprising the feature that the throttle twist grip has an angle of rotation limiting device which is arranged in or substantially in the axial plane of the holder, offer the advantage that the housing can have a very short design in an axial direction. This is of advantage in particular due to the small installation space available. The connection which preferably has a play (to provide the idling play in a simple way) between grip tube and holder is advantageously arranged in or substantially in the axial plane of the throttle twist grip. For example, the connection can be established by a catch protruding radially outwards into a recess of the holder, wherein the width of the recess is preferably greater by the desired idling play than the width of the catch in the peripheral direction.

The embodiments of the invention, comprising the feature that the throttle twist grip has a friction device which is designed so as to have a greater frictional resistance in the actuating direction than counter to the actuating direction upon actuation of the throttle twist grip, offers the advantage that the throttle twist grip has an operating characteristic which substantially corresponds to the operating characteristic of a throttle twist grip having a Bowden cable and a spring-loaded actuator. According to the invention, the friction device can here also be integrated into the spring device.

According to the invention, the throttle twist grip can have a spring device one end of which is attached to the holder and the other end of which is attached to a part connected in rotationally fixed fashion to the handlebar tube, e.g. the housing of the throttle twist grip.

According to the invention, the holder can be mounted rotatably on the housing and/or on the grip tube.

According to the invention, the holder and the grip tube can be mounted rotatably on the housing, wherein it is preferred that the holder can additionally be mounted rotatably on the grip tube.

According to the invention, the housing can have a projection which protrudes radially inwards and on which the idling stop and a full-throttle stop are formed.

Alternatively or additionally, the idling stop and/or the full-throttle stop can be formed on a further projection which preferably protrudes radially inwards or a shoulder which preferably extends radially inwards. Here, an idling stop and/or full-throttle stop can both be provided on the housing. Alternatively, it is also possible to form several idling stops and/or full-throttle stops on the housing.

According to the invention, the grip tube can have a catch which is preferably formed on the grip tube end that is the inner one in relation to the throttle twist grip and which preferably protrudes radially outwards.

The grip tube end which is the inner one in relation to the throttle twist grip refers in conjunction with the present disclosure to the grip tube end which is arranged further towards the vehicle center or handlebar center in the case of a throttle twist grip mounted on a handlebar of a two-wheeled vehicle, preferably a motor bike and/or a bicycle.

According to the invention, the holder can have a recess for receiving part of the grip tube, wherein in the peripheral direction the recess preferably has a width which is greater by an idling play than the width in the peripheral direction of the grip tube part received in the recess.

According to the invention, the throttle twist grip can have an angle of rotation limiting device for limiting the possible angle of rotation between the housing and the holder and can have a connection between the holder and the grip tube with a play in the peripheral direction, wherein the angle of rotation limiting device is preferably arranged in an axial plane the same as the connection between the holder and the grip tube.

According to the invention, the angle of rotation limiting device can have a projection which is arranged on the housing, protrudes radially inwards from the housing wall and defines an idling stop and a full-throttle stop, and can have a recess which is provided on the outer periphery of the holder and defines an idling stop and a full-throttle stop.

According to the invention, the cruise control switch-off device can have a bolt which is preferably biased by a compression spring, wherein the compression spring preferably has a spring force in the peripheral direction that is smaller than the reset force taking effect during the actuation of the throttle twist grip and/or the spring device of the throttle twist grip.

According to the invention, the cruise control switch-off device can be arranged in the holder at the idling stop in such a way that the bolt protrudes in the direction of the idling stop of the housing and/or the cruise control switch-off device can be arranged in the projection of the housing at the idling stop in such a way that the bolt protrudes in the direction of the idling stop of the holder and/or the cruise control switch-off device can be arranged in the catch of the grip tube and/or in the holder in such a way that the bolt protrudes into the idling play and/or into the holder recess receiving the catch of the grip tube.

According to the invention, the throttle twist grip can have a further position detection device for detecting a cruise control switch-off position, wherein the further position detection device preferably has a sensor arranged in the area of the idling stop and a position indicator which is preferably arranged on the bolt and/or is integrated in the bolt and/or wherein the further position detection device preferably has a sensor arranged on the housing and a position indicator arranged on the holder and/or the grip tube, which are preferably arranged so as to detect a position when the throttle twist grip is actuated so as to leave the idling position counter to the actuating direction.

Advantageously, the sensors are arranged on the rotationally fixed housing, which has the advantage that a connection cable can be laid and connected more easily. The position indicators are then arranged on the rotatable part. This advantage is important in particular for the position detection device for detecting the throttle position, where an angular range of about 85 degrees has to be detected. However, the position detection device for detecting the cruise control switch-off only has to detect a small angular range of about 5 degrees, and this is why the sensor can also be arranged on the rotatable part and the position indicator on the rotationally fixed part. Advantageously, the sensor is here arranged on a part which is separated from the holder when the idling position is left in the direction of the full-throttle position and/or is only approached by the holder and/or the grip tube when the idling position is reached.

Of course, the sensors can also be arranged on a rotatable part and the position indicators can be arranged on the rotationally fixed part. This is of advantage e.g. in throttle twist grips having a grip heating device where the connection cable for the sensor can be laid together with the supply cable for the heating device.

According to the invention, the throttle twist grip can have a connection cable for the output signal of the position detection device and/or a connection cable for a grip heating device which is arranged in the housing of the throttle twist grip in a shape with at least one loop or in loop-shaped fashion. These embodiments of the invention have the advantage that the length is compensated by laying the connection cable in the shape of at least one loop, said compensation being necessary due to the supply of the line to the throttle twist grip to be rotated about an axis of rotation.

In connection with the above disclosure, the actuating direction is the direction in which the grip tube is rotated in relation to the housing of the throttle twist grip by the rider during the acceleration operation.

The invention is described in more detail below by means of the exemplary embodiments shown in the figures.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 shows a sectional view of a throttle twist grip according to an embodiment of the invention along line I-I of FIG. 3;

FIG. 2 shows a side view of the throttle twist grip of FIG. 1;

FIG. 3 shows a sectional view of the throttle twist grip of FIG. 1 along line III-III of FIG. 2;

FIG. 4 shows a sectional view of the throttle twist grip according to an embodiment of the invention along line IV-IV of FIG. 2, which has a cruise control switch-off device in addition to the embodiment according to FIG. 1;

FIG. 5 shows a sectional view of a throttle twist grip according to an embodiment of the invention along line V-V of FIG. 7;

FIG. 6 shows a side view of the throttle twist grip of FIG. 5;

FIG. 7 shows a sectional view of the throttle twist grip of FIG. 1 along line VII-VII of FIG. 6;

FIG. 8 shows a sectional view of a throttle twist grip according to an embodiment of the invention along line VIII-VIII of FIG. 10;

FIG. 9 shows a side view of the throttle twist grip of FIG. 8; and

FIG. 10 shows a sectional view of the throttle twist grip of FIG. 1 along line X-X of FIG. 9.

FIG. 11 is a fragmentary, side elevational view and a block diagram of a twist grip unit;

FIG. 12 is a fragmentary, longitudinal, cross-sectional view of the twist grip unit of FIG. 11 along section line XII-XII;

FIG. 13 is a radially cross-sectional view of the twist grip unit of FIG. 11 along section line XIII-XIII;

FIG. 14 is a fragmentary, perspective view of the twist grip unit of FIG. 13 along section line XIV-XIV;

FIG. 15 is a fragmentary, side perspective view of twist grip unit of FIG. 11 along section line XV-XV;

FIG. 16 is a graph depicting a course of a torsional moment plotted against an angle of rotation between an initial position and a maximum rotational position; and

FIG. 17 is a side elevational view of a twist grip unit similar to FIG. 15.

The description of the exemplary embodiment uses the following reference signs:
1 actuating direction
10 throttle twist grip
20 housing
21 projection
22 idling stop
23 full-throttle stop
24 clamping device
25 basic body
26 housing cover
30 grip tube
31 catch
32 idling play (angle α)
39 hand rest body
40 position detection device
41 position indicator (e.g. magnet)
42 sensor (e.g. Hall sensor)
50 holder
51 recess
52 idling stop
53 full-throttle stop
54 recess (to receive the catch 31; in the peripheral direction, the width of the recess 54 of the holder is greater by the idling play 32 than the width of the catch 31)
55 support (for position indicator 41)
60 spring device (e.g. torsion spring)
61 end of the torsion spring (suspended in the holder 50)
62 end of the torsion spring (suspended in the housing 20)
70 cruise control switch-off device
71 compression spring
72 bolt
80 friction device (e.g. friction sleeve)
140 position detection device
141 position indicator (e.g. magnet)
142 sensor (e.g. Hall sensor)
240 position detection device
241 position indicator (e.g. magnet)
242 sensor (e.g. Hall sensor)

### DETAILED DESCRIPTION OF THE INVENTION

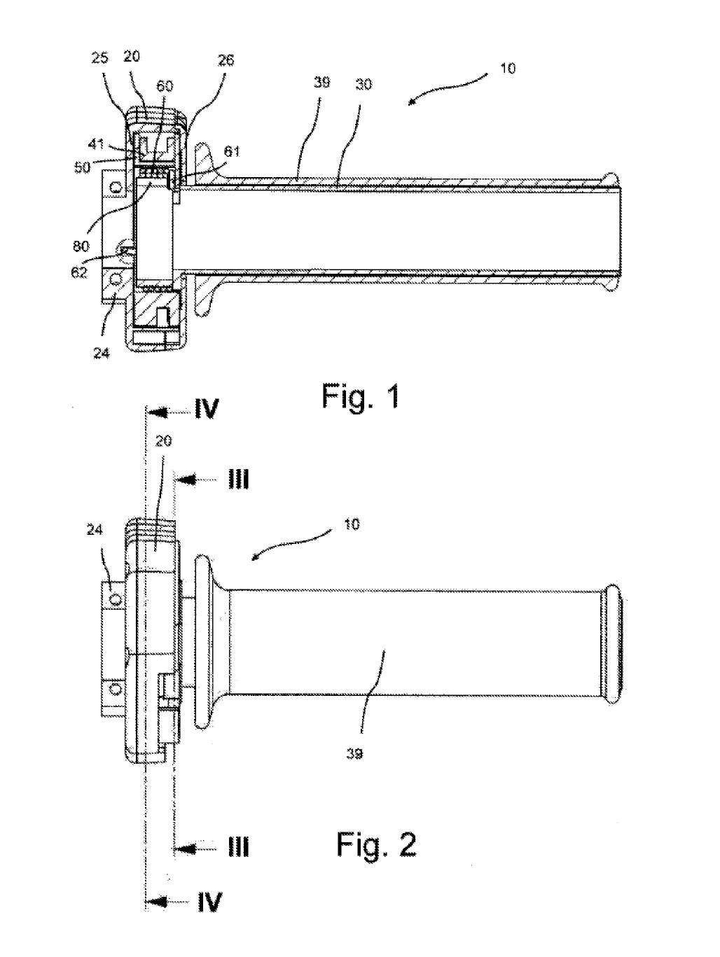

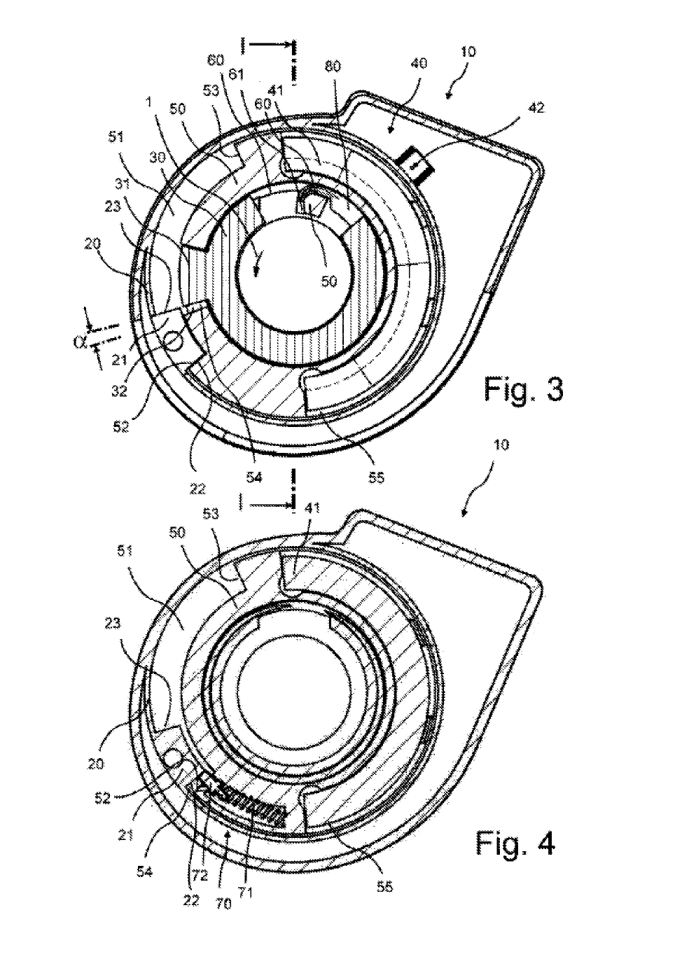

FIGS. 1 to 4 show a first exemplary embodiment of a throttle twist grip 10 according to the invention.

The throttle twist grip 10 has a housing 20. The housing 20 is mounted in known manner on a handlebar tube (not shown) by means of a clamping device 24.

The housing 20 preferably has a two-part design and includes a basic body 25 and a housing cover 26. Alternatively, the housing can also be made of one piece or of several pieces.

In the housing 20, a grip tube 30 is mounted rotatably which accommodates a hand rest body 39 that is gripped with one hand by the rider of the handlebar-controlled vehicle (e.g. motorbike, trike, quad or bicycle having an auxiliary power means).

The housing 20 accommodates a projection 21 where an idling stop 22 and a full-throttle stop 23 are provided. The projection 21 protrudes radially inwards from the housing wall. The idling stop 22 and a full-throttle stop 23 are provided on both sides thereof.

The throttle twist grip comprises a position detection device 40 having a position indicator 41 which can be e.g. a magnet or another position indicator known to a person skilled in the art, and a sensor 42 which can be e.g. a Hall sensor or another sensor that is known to the person skilled in the art and serves for detecting the relative position of the position indicator.

The throttle twist grip has a holder 50 having a support 55 in which the position indicator 41 (e.g. a magnet) is arranged.

The holder 50 has a recess 51 at one end of which an idling stop 52 is provided and at the other end of which a full-throttle stop 53 is disposed. Said stops cooperate with the corresponding idling stop 22 and full-throttle stop 23, respectively, of the projection 21 of the housing 20, said projection protruding into the recess 51, and define the possible adjusting range of the throttle twist grip 10, which is approximately 85 degrees in the embodiment as shown and/or corresponds to the possible adjusting range of known throttle twist grips having a Bowden cable and a spring-loaded actuator.

The grip tube 30 has a catch 31 which protrudes radially outwards at the axially interior end of the grip tube 30.

The holder has a further recess 54 which accommodates the catch 31, wherein the width of the recess 54 of the holder in the peripheral direction about the idling play 32 (angle α) is greater than the width of the catch 31.

The throttle twist grip 10 also has a spring device 60, e.g. a torsion spring, one end 62 of which is suspended in the housing 20 and the other end 61of which is suspended in the holder 50.

For the purpose of acceleration, the grip tube 30 is turned from an idling position in the actuating direction 1 until the idling play 32 has been overcome. Then, the catch 31 carries along the holder 50 which upon further actuation departs with its idling stop 52 from the idling stop 22 of the housing 20. The throttle twist grip 10 can be turned further until the full-throttle stop 53 of the holder 50 abuts against the full-throttle stop 23 of the housing 20. Once the catch 31 of the grip tube 30 turns the holder 50 in relation to the housing, this changes the output signal of the position detection device 40, which can be used as usual to correspondingly operate the motor control, i.e. to accelerate.

The throttle twist grip 10 also has a friction device 80, e.g. a friction sleeve. The latter is advantageously made in such a way that an acceleration operation is accompanied by a higher friction resistance as compared to a deceleration operation (actuation of the throttle twist grip 10 counter to the actuating direction 1).

The throttle twist grip can optionally have a cruise control switch-off device 70 which in the embodiment as shown has a compression spring 71 and a bolt 72. The bolt 72 is arranged together with the compression spring 71 in the holder 50 and is biased in the idling position of the throttle twist grip 10 against the idling stop 22. When the throttle twist grip 10 is rotated so as to leave the idling position counter to the actuating direction 1, the bolt 72 is pushed against the force of the compression spring 71 in the direction of the holder 50. Having exceeded a certain distance, a signal can be produced in a way known to the person skilled in the art, said signal turning off the cruise control. It is possible to rotate the throttle twist grip so as to leave the idling position counter to the actuating direction because it is possible to traverse the idling position against the spring force of the compression spring 71, i.e. the throttle twist grip has a spring-mounted idling position. The spring force of the compression spring is advantageously smaller than the spring force of the spring device 60.

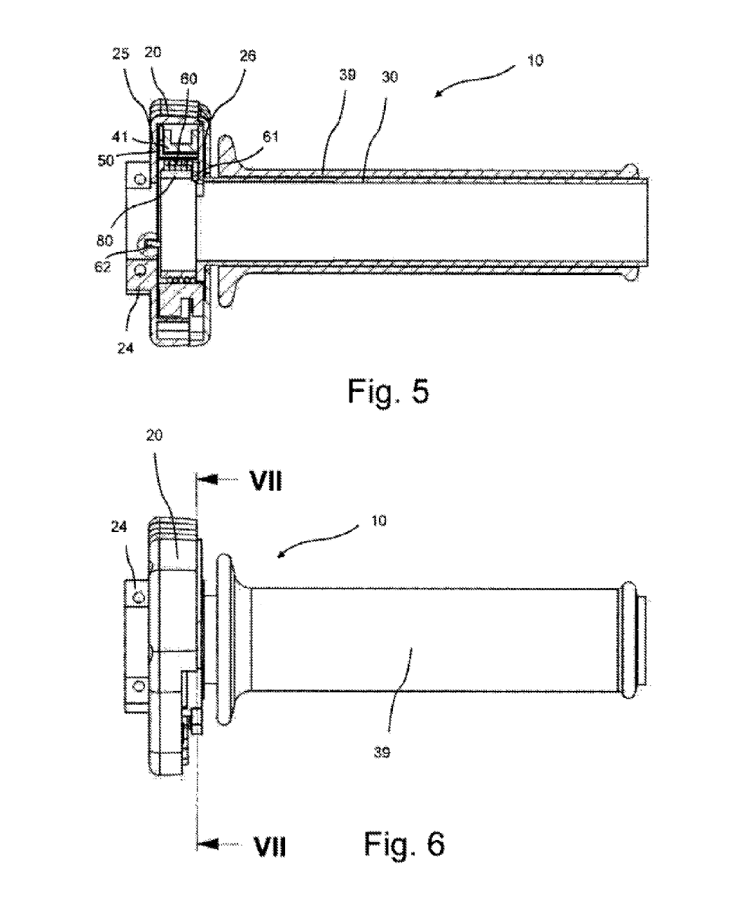

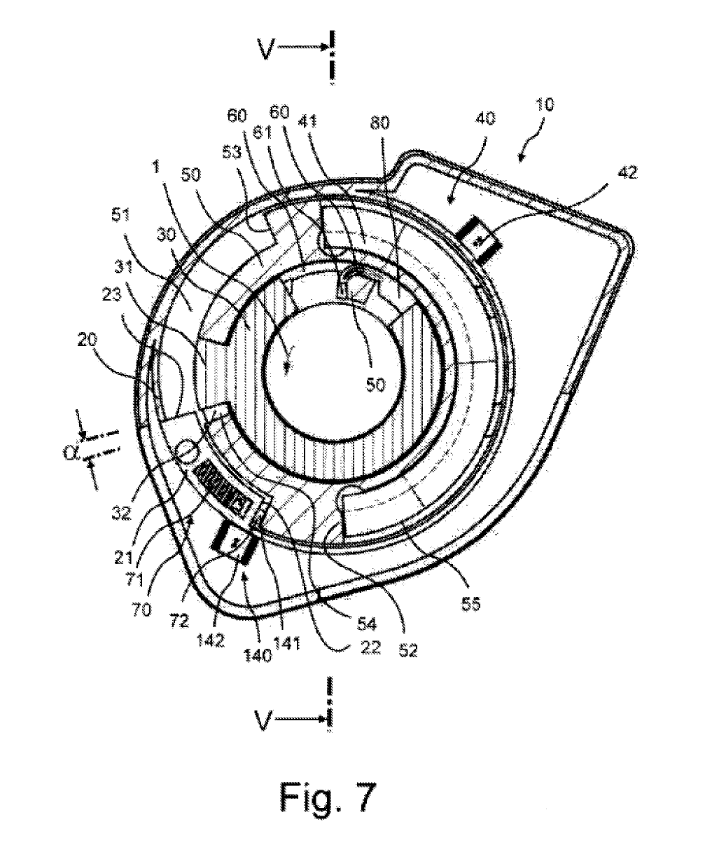

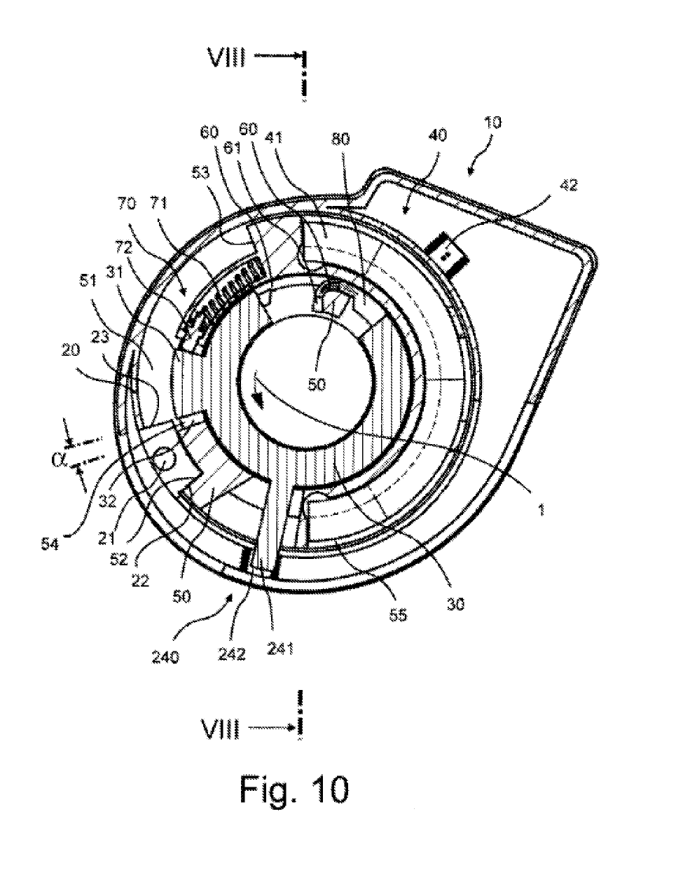

FIGS. 5 to 7 and 8 to 10 show further embodiments of the invention. Said embodiments substantially distinguish themselves by different designs of the cruise control switch-off device 70 and by the provision of a further position detection device 140 and/or 240. Therefore, reference is made below to the description of the embodiments according to claims 1 to 4 and the focus is laid on the differences between the exemplary embodiments of the invention.

FIGS. 5 to 7 show an embodiment of the invention where the cruise control switch-off device 70 is arranged in the projection 21 of the housing 20. The bolt 72 protrudes from the projection beyond the idling stop 22 and is biased by means of a compression spring 71 in the direction of the idling stop 52, wherein the bolt 72 contacts the idling stop 52 in the idling position of the throttle twist grip and/or shortly before reaching the idling position.

The embodiment of the invention, which is shown in FIGS. 5 to 7, comprises a further position detection device 140 which has a position indicator 141 integrated into the bolt 72 and a sensor 142 arranged on the housing 20.

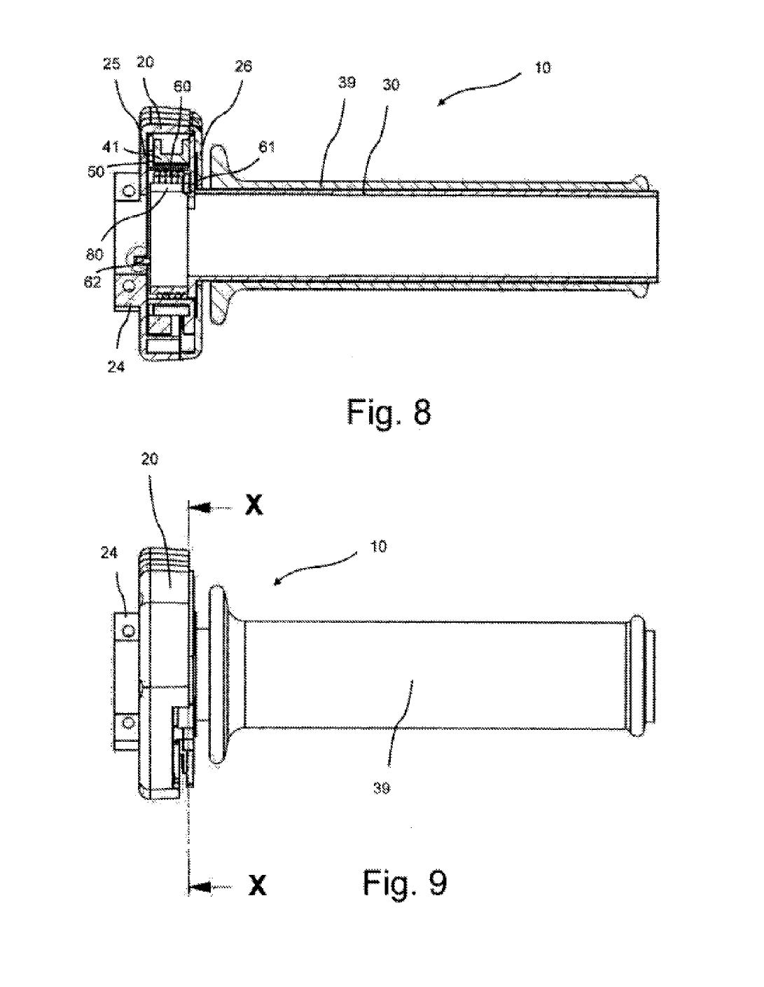

FIGS. 8 to 10 show an embodiment of the invention where the bolt 72 of the cruise control switch-off device 70 protrudes into the recess 54 which accommodates the catch 31 of the grip tube 30. The cruise control switch-off device 70 of said embodiment is arranged in the holder. An embodiment (not shown) in which the cruise control switch-off device 70 is arranged in the catch 31 would also be conceivable.

The embodiment of the invention, which is shown in FIGS. 8 to 10, comprises a further position detection device 240 which has a position indicator 241 that is arranged on a radial projection of the holder 50 and a sensor 242 that is arranged on the housing 20.

The cruise control switch-off can be effected by the cruise control switch-off device 70 and/or by a signal of the position detection device 140 and/or 240 when the throttle twist grip is turned counter to the actuating direction beyond the idling position.

The throttle twist grips which comprise the features of the present invention can advantageously be developed further by additional features of patent application DE 10 2008 051 609.0 filed on Oct. 7, 2008, in particular as regards the friction device disclosed therein. The following disclosure of this patent application shall thus also be the subject matter of the present description:

In order to improve a twist grip unit for actuating an electric or electronic actuator, in particular an actuator for controlling the speed of a motor, comprising a twist grip base, a twist grip rotatable in relation to the twist grip base about an axis of rotation, a spring element which acts on the twist grip in the direction of an initial position and against the action of which the twist grip can be rotated from the initial position in the direction of a maximum rotational position, in such a way that in spite of the use of an electric or electronic actuator the twist grip unit shows an actuation behavior which the user knows from a Bowden cable actuated by the twist grip and a spring-loaded actuator, it is proposed that a friction element is assigned to the twist grip in addition to the spring element, said friction element producing a friction resistance when the twist grip is rotated from the initial position in the direction of the maximum rotational position that is greater than that occurring when the twist grip is turned in the opposite direction.

Therefore, the invention additionally relates to a throttle twist grip which also comprises one or more of the following features:

a twist grip unit for actuating an electric or electronic actuator, in particular an actuator for controlling the speed of a motor, comprising a twist grip base, a twist grip which can be rotated about an axis of rotation in relation to the twist grip base, a spring element which acts upon the twist grip in the direction of an initial position and against the action of which the twist grip can be rotated from the initial position in the direction of a maximum rotational position, wherein a friction element is assigned to the twist grip in addition to the spring element, said friction element producing a friction resistance when the twist grip is rotated from the initial position in the direction of the maximum rotational position that is greater than that occurring when the twist grip is turned in the opposite direction.

the friction element is assigned to the spring element.

the friction element acts on the spring element.

the spring element is designed as a spiral coiled spring.

the spiral coiled spring has turns which extend about the axis of rotation and are disposed next to one another in a direction parallel to the axis of rotation.

the friction element acts on the turns of the spring element.

the spiral coiled spring reduces a spiral coil diameter when the twist grip is rotated from the initial position in the direction of the maximum rotational position.

the friction element has an abutment face against which the turns of the spiral coiled spring frictionally abut.

the force with which the turns of the spiral coiled spring act on the abutment face is greater when the twist grip is rotated from the initial position in the direction of the maximum rotational position than that occurring when the twist grip is turned in the opposite direction.

the friction element has an abutment face elastically movable in a radial direction in relation to the axis of rotation.

the friction element is made as a body extending in curved fashion about the axis of rotation.

the friction element is made as a C-shaped body of flat material, the ends of which are spaced apart in the peripheral direction.

the friction element is made as a body of flat material, the end regions of which overlap in the peripheral direction.

the friction element is made as a body arranged in the spiral coiled spring interior, on the abutment face of which the spiral coiled spring rests by means of its turns.

as an abutment face, the body has an outer peripheral side on which the turns of the spiral coiled spring rest.

the spring element is arranged in a twist grip base interior.

the friction element is arranged in a twist grip base interior.

the friction element is rotationally fixed in the twist grip base.

the twist grip has a play in the initial position thereof.

the spring element is kept at a minimum bias in the initial position by the friction element.

the spring element kept at a minimum bias is connected with play to the twist grip base and/or the twist grip.

According to the invention, a friction element can be assigned to the twist grip in addition to the spring element. When the twist grip is turned from the initial position in the direction of the maximum rotational position, said friction element produces a friction resistance greater than that occurring when the twist grip is turned in the opposite direction.

The advantage of this solution is that the friction element provides, together with the spring element and the twist grip, an operating characteristic which largely corresponds to that of a twist grip by means of which a Bowden cable and a spring-loaded actuator are actuated and which can also be implemented in an easy and cost-effective way.

In principle, the friction element might be arranged in fully independent fashion from the spring element, e.g. at a location other than that of the spring element, it being advantageous for the friction element to be assigned to the spring element.

However, the friction element can be integrated into a twist grip unit of this type in a particularly favorable fashion when the friction element acts on the spring element.

The spring element has not yet been discussed in more detail.

For example, it would, in principle, be conceivable to design the spring element as a torsion spring or a spiral spring.

With respect to a cooperation of a spring element of this type with a friction element, it has, however, proved to be particularly favorable for the spring element to be made as a spiral coiled spring.

In this case, the spiral coiled spring is preferably made in such a way that it has turns extending about the axis of rotation and being disposed one next to the other in a direction parallel to the axis of rotation. In a spiral coiled spring of this type, the friction element can be integrated into the twist grip in a particularly advantageous fashion when the friction element acts on the turns of the spring element so as to utilize the friction force between the turns of the spring element and the friction element.

A spiral coiled spring can, in principle, be wound in most different ways.

For example, the spiral coiled spring can be coiled in such a way that, when the twist grip is rotated from the initial position in the direction of the maximum rotational position, the diameter of the spiral coiled spring is increased.

However, it has proved to be particularly favorable for the spiral coiled spring to be designed in such a way that when the twist grip is rotated from the initial position in the direction of the maximum rotational position the diameter of the spiral coiled spring is reduced, in particular in the area of the turns which can be turned together with the twist grip.

In order to obtain an optimum friction effect, it is preferred that the friction element has an abutment face against which the turns of the spiral coiled spring abut in frictional fashion.

In order to be able to produce the above mentioned behavior in the case of a spiral coiled spring of this type in connection with the friction element, it is preferred that the force by means of which the turns of the spiral coiled spring act on the abutment face when the twist grip is rotated from the initial position in the direction of the maximum rotational position, is greater than that occurring when the twist grip is turned in the opposite direction.

The friction element can here be basically made as a body having any shape.

For example, the friction element might be made as a cage which abuts against the spiral coiled spring on at least one side thereof.

In order to always obtain an optimum interaction between the spiral coiled spring and the friction element, it is preferred that the friction element has an abutment face elastically movable in a radial direction in relation to the axis of rotation.

Such a design of the friction element provides the possibility that it can cooperate in optimum fashion with a spiral coiled spring, the diameter of which changes in a radial direction in relation to the axis of rotation when rotated, and therefore the friction between the spiral coiled spring and the friction element can be adjusted in accordance with the rotating direction in optimum fashion within the meaning of the present invention.

According to a particularly favorable solution, the friction element is made as a body extending in curved fashion about the axis of rotation.

One possibility is that the friction element is made as a C-shaped body from flat material, the ends of which are spaced apart in the peripheral direction.

An alternative solution is that the friction element is made as a body from flat material, the end regions of which overlap in the peripheral direction.

In this connection, the friction element might encompass the spiral coiled spring, for example.

A solution which is particularly favorable in terms of space and thus particularly suitable for the integration in the twist grip unit is that the friction element is made as a body arranged inside the spiral coiled spring and that the turns of the spiral coiled spring rest on abutment face of said body.

A particularly favorable solution is that the body has as an abutment face an outer peripheral side on which the turns of the spiral coiled spring rest.

The arrangement of the spring element has not been discussed any further in connection with the former solution.

In principle, it would be conceivable to arrange the spring element at any site of the twist grip unit.

For example, the spring element might be arranged inside the twist grip, e.g. on a side facing away from the twist grip base, and fixed on a twist grip sleeve, for example. Here, the spring element might be arranged between an end of the support tube and an end of the twist grip or protrude into the support tube.

However, it is particularly useful for the spring element to be arranged in an interior space of the twist grip base.

The friction element can be arranged at any site of the twist grip unit similarly to the spring element.

The friction element might also be arranged inside the twist grip, e.g. on a side facing away from the twist grip base, and be fixed at a twist grip sleeve, for example. In this connection, the friction element might also be arranged between the end of the support tube and the end of the twist grip or protrude into the support tube.

It is also favorable for the friction element to be arranged in an interior space of the twist grip base.

In order to prevent the spatial shift of the friction element, the friction element is preferably kept in rotationally fixed fashion at the twist grip base.

This is preferably achieved in such a way that a projection of the friction element is attached in rotationally fixed fashion at the twist grip base.

In order to convey to the user the operating characteristic known from the solutions including a Bowden cable, it is preferred that the twist grip has a play in the initial position since such a play is also available in a Bowden cable solution.

Such a twist grip play in the initial position can advantageously be achieved by keeping the spring element in the initial position at a minimum bias by the friction element.

Thus, the unit of spring element and friction element in the initial position is such that the spring element has a defined position namely that corresponding to the minimum bias.

In order to be able to achieve a play, it is preferred that the spring element kept at a minimum bias is connected with play to the twist grip base and/or the twist grip.

As a result of this connection with play to the twist grip base and/or to the twist grip, said play can be achieved in the initial position upon actuation of the twist grip since the spring element is in the position corresponding to the minimum bias and thus does not apply a force to the twist grip in the direction of the initial position but only adopts a position corresponding to the initial position, said position, however, only positioning the twist grip in the initial position with play.

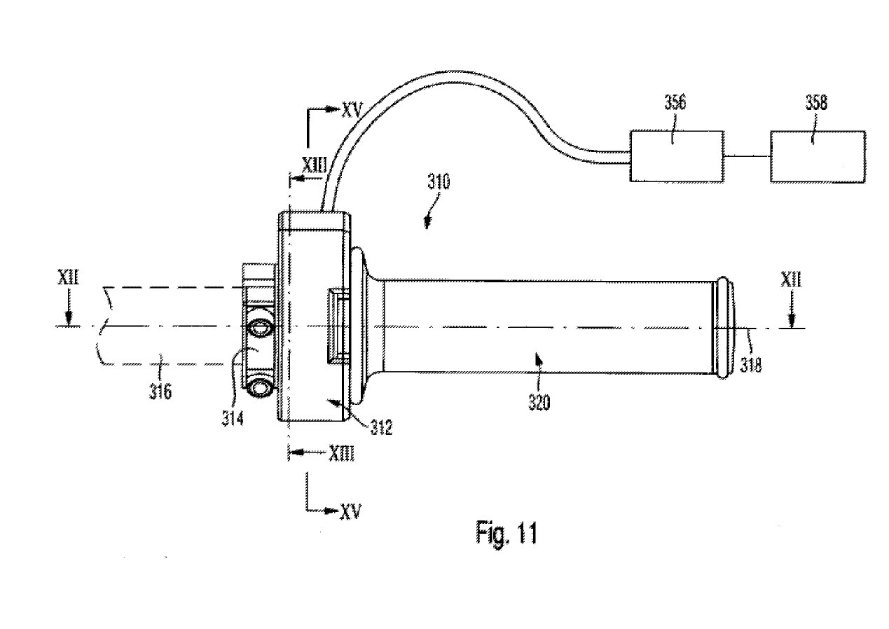

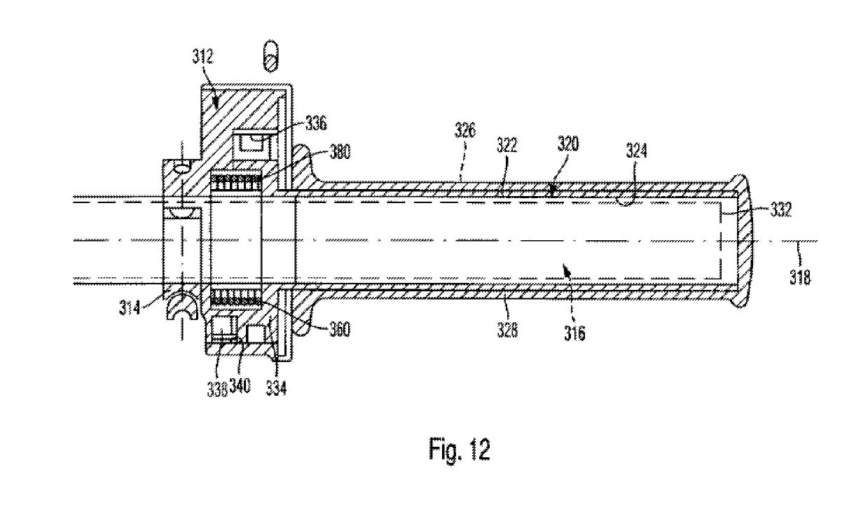

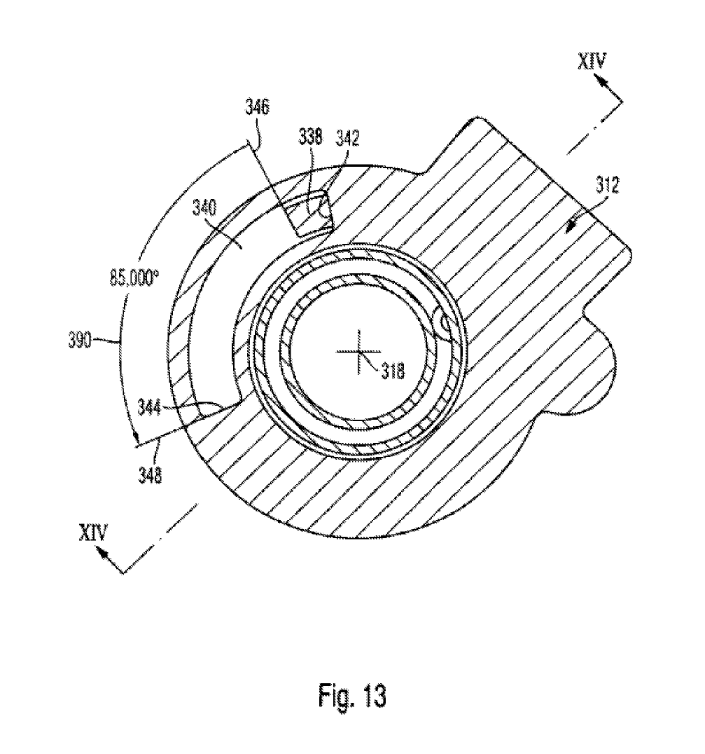

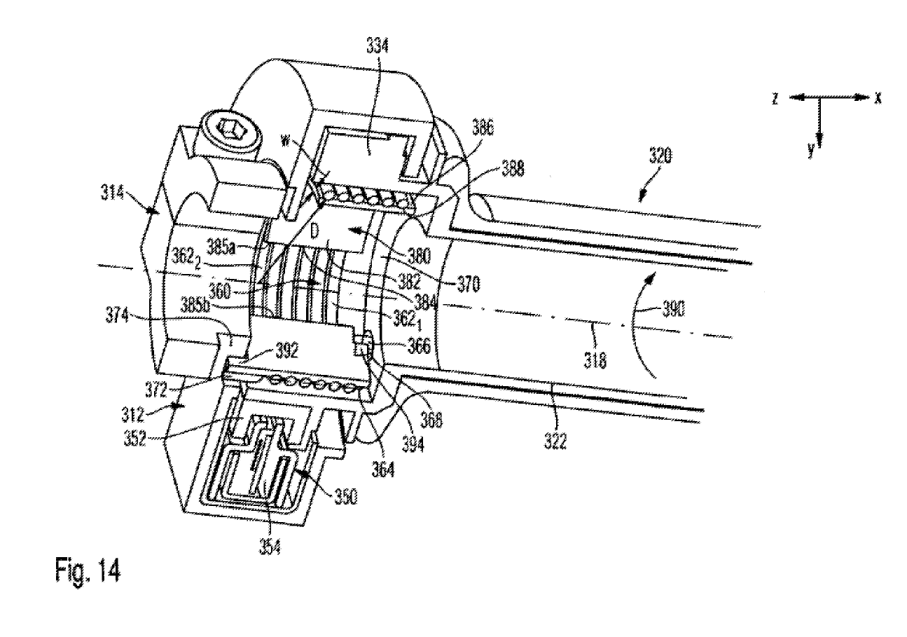

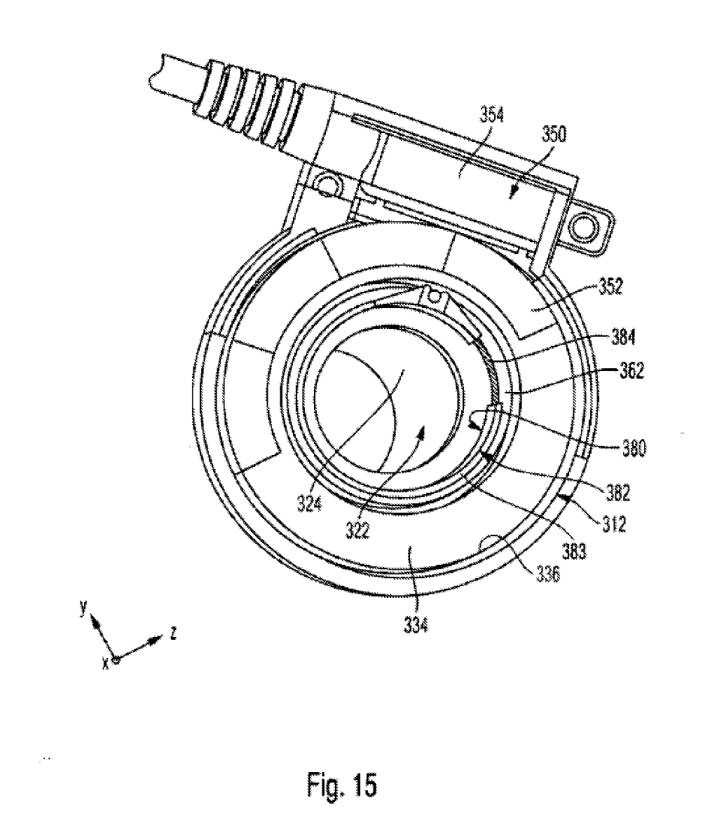

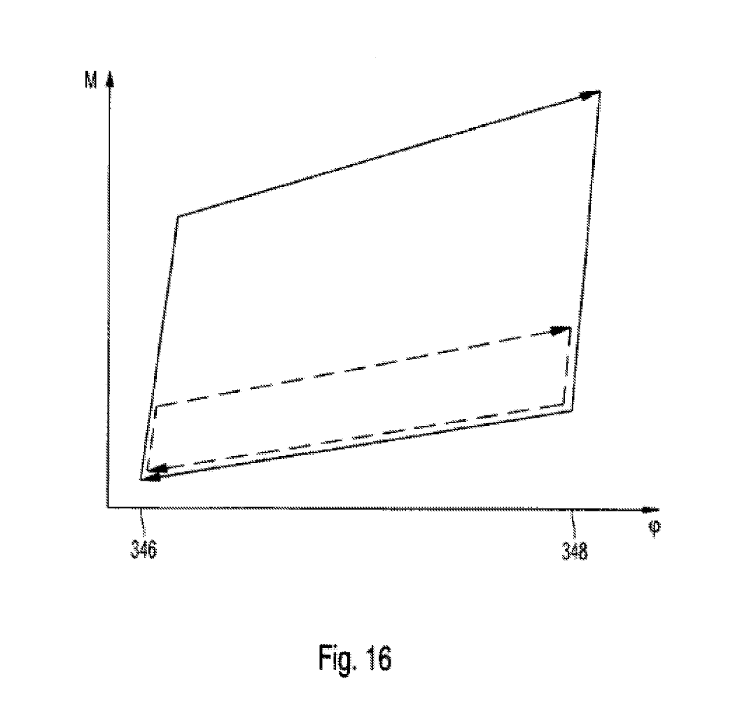

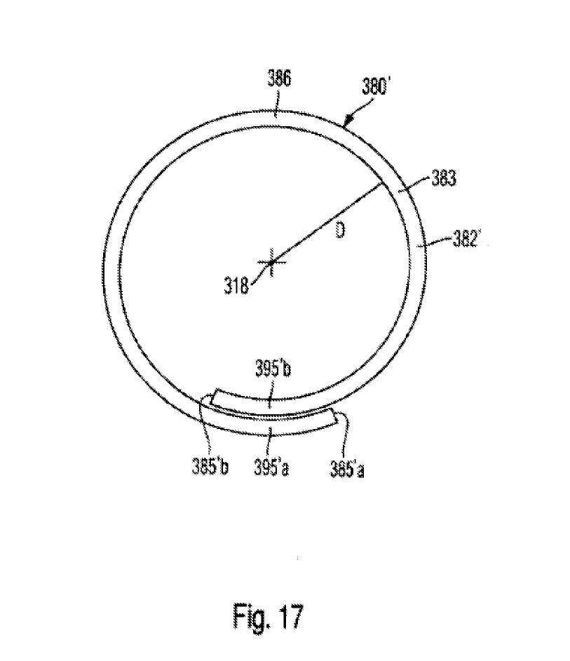

These features are explained by means of the following FIGS. 11 to 17:
FIG. 11 shows an overall view of a twist grip unit;
FIG. 12 shows a section along line XII-XII in FIG. 11;
FIG. 13 shows a section along line XIII-XIII in FIG. 11;
FIG. 14 shows a perspective sectional view of a twist grip unit along line XIV-XIV in FIG. 13;
FIG. 15 shows a perspective sectional view along line XV-XV in FIG. 11;
FIG. 16 shows a diagrammatic view of a course of the torsional moment plotted against an angle of rotation between an initial position and a maximum rotational position; and
FIG. 17 shows a section through a twist grip unit, which is similar to FIG. 15.

A twist grip unit 310, shown in FIG. 11, comprises a twist grip base 312 which can be mounted in rotationally fixed fashion, e.g. by means of a clamping unit 314, on a support tube 316, e.g. a handlebar tube.

A twist grip 320 which can be rotated in relation to the twist grip base 312 and in relation to the support tube 316 about an axis of rotation 318 is mounted on the twist grip base and, as shown in FIG. 12, comprises a twist grip sleeve 322 which is slidably guided by means of an inner face 324 about the axis of rotation 318 in rotating fashion on an outer face 326 of the support tube 316.

The twist grip sleeve 322, in turn, additionally carries a hand rest body 328 which overlaps said sleeve and is made from a flexible material as well as is encompassed by a hand for turning the twist grip 320.

The twist grip sleeve 322 extends from the twist grip base 312 at least up to an outer end 332 of the support tube 316 and is fixedly connected to a support body 334 which is arranged in an inner space 336 of the twist grip base 312 and, on the one hand, is rotatably guided in the inner space 336 and, on the other hand, is held undisplaceably in the direction of the axis of rotation 318. Therefore, as a result of the fixed connection between the support body 334 and the twist grip sleeve 322, the entire twist grip 320 is rotatable about the axis of rotation 318, yet it is not slidable in the direction of the axis of rotation 318.

In order to confine the rotatability of the twist grip 320 about the axis of rotation 318, the support body 334 is also provided with a lug 338, as shown in FIG. 13. Said lug meshes with a recess 340 which has the shape of a segment of an annular space about the axis of rotation 318 and is disposed in the twist grip base 312, wherein the recess 340 confines the rotatability of the twist grip 322 by means of end faces 342 and 344 which extend in a radial direction in relation to the axis of rotation 318 and against which the lug 338 can abut, to a maximum angle of rotation at the order of 90° or less.

In this connection, the end face 342 defines an initial position 346 of the lug 338 and thus of the twist grip 320 and the end face 344 defines a maximum twist position 348 which with respect to the initial position 346 is arranged at an angular distance by the above mentioned maximum angle of rotation of the twist grip 320 with respect to the initial position 346.

In the case of conventional known twist grip units 310, an actuator is actuated via a Bowden cable which is attached to the support body 334, said actuator controlling e.g. a mixture supplied to an internal combustion engine, wherein the actuator is biased by a return spring in such a way that the former always moves into a position that corresponds to the initial position 346 of the twist grip 320.

In the twist grip unit according to the invention, no Bowden cable is connected to the support body 334, as shown in FIG. 14; however, a sensor unit 350 is provided which detects the rotational positions of the support body 334 between the initial position 346 and the maximum rotational position 348.

For example, the sensor unit 350 is a sensor unit which operated without contact and comprises a rotatable element 352 fixedly held at the support body 334 and a sensor element 354 fixedly arranged in the twist grip base 312, said sensor element having e.g. one or more integrated Hall sensors which can detect magnetic fields of the rotatable element 352, wherein the rotatable element 352 is e.g. a body having a plurality of magnetized zones, and therefore the rotational position of the rotatable element 352 based on the axis of rotation 318 and thus also the rotational position of the entire twist grip 320 based on the axis of rotation 318 can be detected with the necessary precision when the plurality of magnetized zones of the rotatable element 352 moves past the sensor element 354.

The sensor unit 350 cooperates with a control 356, wherein both form an electronic actuator for controlling an engine 358, e.g. an internal combustion engine.

Since no restoring moment occurs in a sensor unit 350 of this type in the direction of the initial position 346 by the electronic actuator, a spring element referred to by 360 as a whole is provided that takes effect between the twist grip base 312 and the twist grip 320 and biases the twist grip 320 in the direction of its initial position 346 with a moment of rotation.

For this purpose, the spring element 360 is preferably formed as a spiral coiled spring which has a plurality of turns 362 that are disposed side by side on a cylindrical surface 364 in the direction of the axis of rotation 318, which is approximately coaxial in relation to the axis of rotation 318.

In addition, a first turn 362₁ facing the twist grip sleeve 322 has a bend 366 extending transversely to the first turn 362₁, e.g. approximately parallel to the axis of rotation 318, said bend meshing with a support 368 in the twist grip sleeve 322, e.g. in a flange section 370 of the twist grip sleeve 322, and following the latter in the case of a rotary movement of the twist grip 320. The support 368 can be designed e.g. as an elongated hole or otherwise with play.

Furthermore, a last turn 362ₙ opposite to the first turn 362₁ also has a bend 372 which also extends approximately parallel to the axis of rotation 318 and is fixed in a support 372 provided for this purpose in the twist grip base 312 (FIG. 14).

Thus, the part of the spring element 360, which is connected to the bend 372, is mounted in rotationally fixed fashion in relation to the twist grip base 312 while the part of the spring element 360, which is connected to the bend 366, is simultaneously rotated when the twist grip 320 is turned about the axis of rotation 318.

In order to convey to a user who turns the twist grip 320 a feeling of turning which is the same as that in the case of the known twist grip units pulling on a Bowden cable, a friction element, which is referred to by 380 as a whole, is assigned to the spring element 360 and, as shown in particular in FIG. 15, is made as a sleeve 382, e.g. from flat material 383, that has a slot 384 extending in the direction of the axis of rotation 318 and being confined by ends 385a, 385b, e.g. of the flat material 383, as well as has an outer abutment face 386 which always abuts against an inner side 388 of the individual turns 362 of the spring element 360.

For example, the sleeve 382 can also be provided with lateral guide elements which extend radially outwards for the turns 362 of the spring element 360 or be made of a material having an L-cross-sectional shape or a U-cross-sectional shape in planes extending through the axis of rotation 318.

For this purpose, the sleeve 382 is made of a material radially spreading in relation to the axis of rotation 318, and therefore the sleeve 382 always tends to abut via its abutment face 386 against the inner sides 388 of the individual turns 362 of the spring element 360 while widening the slot 384 so as to establish a constant frictional contact between the abutment face 386 of the sleeve 382 and the inner side 388 of the turns 362.

When the twist grip 320 is turned in the rotation direction 390 from the initial position 346 in the direction of the maximum rotational position 348, the result is on account of the winding sense of the turns 362 that, since the bend 366 is rotationally carried along, an inner diameter D of the turns 362i etc. of the spring element 360 is reduced and therefore the individual turns 362 of the spring element 360 move via their inner side 388 in relation to the abutment face 386 and also act upon the sleeve 382 by means of their inner side 388 in such a way that the diameter D of the former is also reduced in relation to the axis of rotation 318, wherein in this case the slot 384 is not widened but narrowed.

When a wall thickness W of the flat material 383 of the sleeve 382 is adjusted, it is also possible to influence and adjust the resilient behavior radial to the axis of rotation 318 in such a way that the action of the friction element 380 corresponds approximately to a friction resistance of a Bowden cable, which the user has felt in the hitherto known twist grip units 310 actuating a Bowden cable, when the twist grip 320 is turned in the rotational direction 390 from the initial position 346 in the direction of the maximum rotation position 348. The resilient behavior of the sleeve 382 can alternatively be influenced or adjusted by adjustment of the length, material selection, bias, abutment face and/or encompassment.

The spring element 360, in turn, acts on the rotation of the twist grip 320 in the rotating direction 390 in such a way that based on the initial position 346 said rotation requires an constantly increasing torsional moment with increasing rotation of the twist grip 320, said torsional moment increasing linearly with the angle of rotation, for example.

When the hand of the user stops exerting an influence in the rotation direction 390 but applies a reduced torsional moment and therefore the twist grip 320 can return, based on the current rotation position thereof, into the initial position 346 by the action of the spring element 360, the spring element 360 will increase the diameter D of the individual turns 362, wherein the friction between the inner sides 388 of the individual turns 362 and the abutment face 386 of the sleeve 382 is smaller when the rotation is effected counter to the rotation direction 390, which also corresponds to the behavior of a twist grip unit 310 actuating a Bowden cable.

This course of the torsional moment M acting on the twist grip 320 above the angle of rotation φ in the rotation direction 390 is shown in FIG. 16 for the twist grip unit 310. The leap of the torsional moment M which occurs with a rotation in the rotation direction 390 based on the initial position 346 is substantially caused by the friction element 380 and the resulting friction between said element and the spring element as shown by a comparison with the dot-dashed curve in FIG. 16, said curve illustrating the course of the moment acting on the twist grip 320 when the spring element 360 is used but without the friction element 380. Therefore, only the friction of the system, which occurs e.g. between the twist grip sleeve 322 and the support tube 316, is relevant for the leap of the torsional moment M in the initial position (FIG. 16).

In addition, FIG. 16 shows that with a rotation counter to the rotation direction 390 the course of the moment M above the angle φ corresponds approximately to the course without the friction element 380, and therefore, when rotated counter to the rotation direction 390, the friction element 380 is much less effective compared to the rotation in the rotation direction 390. As a result, the behavior of a Bowden cable on which a known twist grip unit acts can be imitated by the friction element 380 since a Bowden cable of this type also showed an essentially smaller friction the twist grip was rotated counter to the rotation direction 390 and thus was turned back in the direction of the initial position 346 compared to a rotation in the rotation direction 390.

In addition, the sleeve 382 is preferably made in such a way that it also has a projection 392 which also meshes with the support 374 in the twist grip base 312 to mount a portion of the sleeve 382 in rotationally fixed fashion in relation to the twist grip base 312, thus preventing turning of the sleeve 382 in relation to the spring element 360.

The projection 392 is preferably made so as to receive the bend 372 of the spring element 360, as shown in FIG. 15, and encompass it on both sides in such a way that the bend 372 and the projection 392 can be mounted in rotationally fixed fashion in the support 374.

In addition, the spring element 360 can be mounted with a bias on the sleeve 382 when not only the bend 372 in the projection 392 is mounted in relation to the sleeve 382 but also the bend 366 abuts against a lug 394 of the friction element 380, said lug protruding radially outwards beyond the abutment face 386 and keeping the spring element 360 at a minimum bias and also keeping the bend 366 oriented in defined fashion with respect to the bend 372, and therefore there is a play of the twist grip 320 in relation to the twist grip base 312 in the initial position when the support 368 is made as an elongated hole, said play corresponding to the play of the twist grip biasing a Bowden cable so that the twist grip unit is even closer to the known characteristic actuation behavior.

However, the lug 394 permits a movement of the bend 366 in the rotation direction 390, and therefore the bend 366 is lifted from the lug 394 when the initial position is left and again abuts against the lug when returning to the initial position.

In a further twist grip unit, the friction element 380′ is also made as a sleeve 382′, as shown in FIG. 17, wherein the flat material overlaps the end regions 395′a and 395′b bordering on the ends 385′a and 385′b, and therefore the end regions 395′a and 395′b abut against each other.

Thus, the diameter D of the sleeve 382′ can also vary in so far as the end regions 395′a and 395′b overlap to a more or less extent, and therefore the sleeve 382′ can also be resilient in a radial direction in relation to the axis of rotation 318 and the abutment surface 386 can also change its position in relation to the rotation axis 318 in a radial direction to adapt to the diameter of the turns 382 of the spring element 360.

1. A throttle twist grip, comprising
a housing;
a grip tube mounted rotatably about an axis of rotation in relation to the housing;
a position detection device having a position indicator and at least one sensor operable to detect a relative position of the grip tube in relation to the housing;
a holder shaped to receive part of the position detection device; and
at least one of:
the holder being mounted rotatably about the axis of rotation in relation to the grip tube;
the grip tube having a catch operable to carry along the holder upon actuation of the throttle twist grip;
the holder being rotatable about the axis of rotation in relation to the grip tube by an angle corresponding to idling play;
a cruise control switch-off device;
an angle-of-rotation limiting device disposed in or substantially in an axial plane of the holder; and
a friction device operable to have a greater frictional resistance in an actuating direction than counter to the actuating direction upon actuation of the throttle twist grip.

2. The throttle twist grip according to claim 1, further comprising a spring device operable such that, during an acceleration operation, the holder is turned relative to the housing against a spring force of the spring device.

3. The throttle twist grip according to claim 2, further comprising the friction device integrated into the spring device.

4. The throttle twist grip according to claim 2, further comprising a part operable to be rotationally fixed to a handlebar tube, the spring device having ends, one end of the spring device being attached to the holder and the other end of the spring device being attached to the part.

5. The throttle twist grip according to claim 4, wherein the part is rotationally fixed to the housing.

6. The throttle twist grip according to claim 1, wherein the holder is mounted rotatably on at least one of the housing and the grip tube.

7. The throttle twist grip according to claim 1, wherein the holder and the grip tube are mounted rotatably on the housing.

8. The throttle twist grip according to claim 7, wherein the holder is mounted rotatably on the grip tube.

9. The throttle twist grip according to claim 1, wherein the housing has a projection protruding radially inwards and on which an idling stop and a full-throttle stop are formed.

10. The throttle twist grip according to claim 1, wherein the grip tube has:
an inside end; and
a catch mounted on the inside end and protruding radially outwards.

11. The throttle twist grip according to claim 1, wherein:
the holder has a recess shaped to accommodate a part of the grip tube; and
in a peripheral direction, the recess has a width that is greater by an idling play than a width in the peripheral direction of the part of the grip tube that is accommodated in the recess.

12. The throttle twist grip according to claim 1, further comprising:
the angle-of-rotation limiting device operable to limit a possible angle of rotation between the housing and the holder; and
a connection between the holder and the grip tube with play in a peripheral direction, the angle-of-rotation limiting device being disposed in the same axial plane as the connection between the holder and the grip tube.

13. The throttle twist grip according to claim 12, wherein:
the holder has an outer periphery; and
the angle-of-rotation limiting device comprises:
a projection on the housing protruding radially inwards from a wall of the housing and defining an idling stop and a full-throttle stop; and
a recess on the outer periphery of the holder, the recess defining an idling stop and a full-throttle stop.

14. The throttle twist grip according to claim 1, further comprising:
a spring device operable such that, during an acceleration operation, the holder is turned relative to the housing against a spring force of the spring device; and
the cruise control switch-off device having a compression spring and a bolt biased by the compression spring, the compression spring having at least one of:
a spring force in a peripheral direction that is smaller than a reset force taking effect when the throttle twist grip is actuated; and
a spring force in a peripheral direction that is smaller than the spring force of the spring device.

15. The throttle twist grip according to claim 13, wherein:
the housing has a second idling stop; and
the holder has a recess shaped to accommodate a part of the grip tube, and
further comprising the cruise control switch-off device having a compression spring and a bolt biased by the compression spring, the cruise control switch-off device being at least one of:
disposed in the holder at the idling stop such that the bolt protrudes in a direction of the second idling stop;
disposed in the projection of the housing at the second idling stop such that the bolt protrudes in a direction of the idling stop; and
at least one of in the catch of the grip tube and in the holder such that the bolt protrudes into at least one of the idling play and the recess of the holder that receives the catch of the grip tube.

16. The throttle twist grip according to claim 1, wherein the housing has a projection protruding radially inwards and on which an idling stop is formed and further comprising:
the cruise control switch-off device having a compression spring, a bolt biased by the compression spring, and a cruise control switch-off position; and
a further position detection device operable to detect the cruise control switch-off position, the further position detection device having at least one of:
a sensor disposed in an area of the idling stop and a position indicator at least one of disposed on the bolt and integrated into the bolt; and
a sensor disposed on the housing and a position indicator disposed on at least one of the holder and the grip tube,
the sensor and the position indicator being disposed to detect a position when the throttle twist grip is actuated from an idling position counter to the actuating direction.

17. The throttle twist grip according to claim 1, further comprising a connecting cable disposed in the housing in a shape including at least one loop, the connecting cable being at least one of:
an output signal connecting cable for an output signal of the position detection device; and
a grip-heating connecting cable operable to connect to a grip heating device.

18. A throttle twist grip, comprising
a housing;
a grip tube mounted rotatably about an axis of rotation in relation to the housing;
a position detection device having a position indicator and at least one sensor operable to detect a relative position of the grip tube in relation to the housing; and
a holder shaped to receive part of the position detection device, being mounted rotatably about the axis of rotation in relation to the grip tube, and being rotatable about the axis of rotation in relation to the grip tube by an angle corresponding to idling play.

19. The throttle twist grip according to claim 18, further comprising at least one of:
the grip tube having a catch operable to carry along the holder upon actuation of the throttle twist grip;
a cruise control switch-off device;
an angle-of-rotation limiting device disposed in or substantially in an axial plane of the holder; and
a friction device operable to have a greater frictional resistance in an actuating direction than counter to the actuating direction upon actuation of the throttle twist grip.

20. A throttle twist grip, comprising
a housing;
a grip tube mounted rotatably about an axis of rotation in relation to the housing;
a position detection device having a position indicator and at least one sensor operable to detect a relative position of the grip tube in relation to the housing;
a holder shaped to receive part of the position detection device, being mounted rotatably about the axis of rotation in relation to the grip tube, and being rotatable about the axis of rotation in relation to the grip tube by an angle corresponding to idling play; and
at least one of:
the grip tube having a catch operable to carry along the holder upon actuation of the throttle twist grip;
a cruise control switch-off device;
an angle-of-rotation limiting device disposed in or substantially in an axial plane of the holder; and
a friction device operable to have a greater frictional resistance in an actuating direction than counter to the actuating direction upon actuation of the throttle twist grip.
